(19) United States
(12) Patent Application Publication
(10) Pub. No.: US 2015/0309327 A1
(43) Pub. Date: Oct. 29, 2015

(54) IMAGE-STABILIZED LONG-RANGE OPTICAL DEVICE

(71) Applicants: Carl Zeiss Sports Optics GmbH, Wetzlar (DE); Carl Zeiss AG, Oberkochen (DE)

(72) Inventors: Dirk DOBERMANN, Magdala OT Ottstedt (DE); Rainer ROBOTTA, Jena OT Closewitz (DE); Georg GUENTHER, Grosschwabhausen (DE); Jens HOFMANN, Jena (DE); Kurt BECKER, Wettenberg (DE); Tobias THIELE, Erfurt OT Mittelhausen (DE)

(21) Appl. No.: 14/330,772

(22) Filed: Jul. 14, 2014

Related U.S. Application Data
(63) Continuation of application No. PCT/EP2013/050177, filed on Jan. 8, 2013.
(60) Provisional application No. 61/586,288, filed on Jan. 13, 2012.

(30) Foreign Application Priority Data
Jan. 13, 2012 (DE) 102012000859.7

(51) Int. Cl. G02B 27/64; G02B 23/18

(52) U.S. Cl. CPC G02B 27/646; G02B 23/18

(57) ABSTRACT

The invention relates to a binocular long-range optical device, having a first optical channel, which has a first housing and a first arrangement of first optical elements in the first housing. The first arrangement has at least one first optical element movable relative to the first housing. A second optical channel has a second housing and a second arrangement of second optical elements in the second housing. The second arrangement has at least one second optical element movable relative to the second housing. At least one passive stabilization system based on mass inertia for image stabilization in the event of perturbing movements of the first and second housings is provided. The at least one first movable optical element and the at least one second movable optical element are movable relative to one another. The at least one stabilization system has at least one first passive stabilization system based on mass inertia, which acts on the at least one first movable optical element of the first optical channel, and at least one second passive stabilization system based on mass inertia, which acts on the at least one second movable optical element of the second optical channel. The first housing and the second housing are connected to one another by a foldable bridge.

### CROSS REFERENCES TO RELATED APPLICATIONS

This application is a continuation of international patent application PCT/EP2013/050177, filed on Jan. 8, 2013 designating the U.S., which international patent application has been published in German language and claims priority from German patent application No. 10 2012 000 859.7, filed on Jan. 13, 2012, and from U.S. provisional patent application No. 61/586,288. The entire contents of these priority applications are incorporated herein by reference.

### BACKGROUND OF THE INVENTION

The invention generally relates to long-range optical devices of the type of binocular optical devices, but also of the type of monocular optical devices.

A binocular long-range optical device can be a binocular telescope, in particular a pair of binoculars, in the meaning of the present invention.

During the usage of a long-range optical device, for example, a pair of binoculars, perturbing movements of the housing of the long-range optical device have a negative effect on the image quality of the image seen by the user. The perturbing movements acting on the housing result in shaking of the image, which impairs the observation of an object or scenery.

Therefore, binocular long-range optical devices have been proposed, in which at least one optical element movable relative to the respective housing and also a stabilization system for image stabilization in the event of perturbing movements are provided respectively in the first optical channel and in the second optical channel. Due to the relative mobility of at least one optical element in the beam path of the respective optical channel, this optical element and therefore the imaging is therefore decoupled from the movement of the housing. The user therefore perceives an image which is free of shaking or has little shaking in spite of perturbing movements.

In the heretofore known stabilization systems, a differentiation is made between passive stabilization systems based on mass inertia and active stabilization systems based on an actuator system.

In the passive stabilization systems based on mass inertia, the respective movable optical element is gimbal-mounted in the housing via a torsion spring joint, wherein the gimbal mount typically permits a movement of the movable optical element about the horizontal axis, which extends transversely to the longitudinal axis, and the vertical axis relative to the housing of the long-range optical device. Furthermore, such a passive stabilization system based on mass inertia has a damping unit, typically an eddy current damper, whereby the displacement of the movable optical element is damped and the latter is not excited to oscillations.

In contrast, in an active stabilization system based on an actuator system, the at least one movable optical element is actively moved via actuators in relation to the housing, to bring about image stabilization via the actively controlled compensation movements. These binocular long-range optical devices, for example, as described in DE 694 26 246 T2, not only require an actuator system, but rather also a sensor system and also a voltage supply and therefore have a comparatively high weight and are very costly to produce.

The binocular long-range optical device known from the document DE 38 43 776 A1 is equipped with a passive stabilization system based on mass inertia for image stabilization. An optical element movable relative to the housing in the form of an image inversion prism is respectively located in both optical channels. The two image inversion prisms are fastened to a shared carrier, which is gimbal-mounted in the middle between the two optical channels on the housing. The two image inversion prisms are rigidly coupled to one another via the shared carrier. The first housing of the first optical channel and the second housing of the second optical channel are also coupled rigidly and immovably to one another.

This known binocular long-range optical device does have the advantage in relation to binocular long-range optical devices having active image stabilization that it does not require actuators, sensors, and voltage supply, however, the rigid, immovable coupling of the two housings of the two optical channels is disadvantageous, because it deviates from the form of conventional binocular long-range optical devices, which have a foldable bridge between the first optical channel and the second optical channel, so that the user can adapt the spacing of the two eyepieces to his eye spacing. This known binocular long-range optical device having passive image stabilization is therefore not optimally adaptable to the respective user or the user-friendliness thereof is not optimal, respectively.

U.S. Pat. No. 4,235,506 discloses a binocular long-range optical device having active image stabilization.

DE 28 34 158 A1 discloses a binocular long-range optical device having passive image stabilization, wherein an optical element movable relative to the housing is provided in each optical channel, wherein the two relatively movable optical elements are rigidly coupled to one another via a carrier.

U.S. Pat. No. 5,539,575 describes a binocular long-range optical device having image stabilization, which is based on a respective active stabilization system, which is based on an actuator system, for the two optical channels.

U.S. Pat. No. 3,503,663 discloses an optical attachment for image stabilization for a long-range optical device, wherein, in the case of a binocular long-range optical device, such an attachment is respectively provided for each of the two optical channels. The image stabilization is accordingly executed externally in this case and is not integrated in the housing of the binocular long-range optical device, which has the disadvantage that the binocular long-range optical device is top-heavy when the attachment is affixed and is therefore not ergonomic to use.

### SUMMARY OF THE INVENTION

It is an object of the present invention to refine a binocular long-range optical device, which has a passive stabilization system based on mass inertia for image stabilization in the event of perturbing movements, in such a manner that its construction is as close as possible to the construction of conventional binocular long-range optical devices without image stabilization, whereby the acceptance of the binocular long-range optical device is increased.

According to an aspect, an optical device is provided, comprising a first optical channel, the first optical channel having a first housing and a first arrangement of first optical elements arranged in the first housing, the first arrangement having at least one first optical element movable relative to the first housing. The optical device comprises a second optical channel, the second optical channel having a second housing and a second arrangement of second optical elements arranged in the second housing, the second arrangement having at least one second optical element movable relative to the second housing. The at least one first movable optical element and the at least one second movable optical element are movable relative to one another. The optical device further comprises at least one passive stabilization system based on mass inertia for image stabilization in the event of perturbing movements of the first and second housings, the at least one stabilization system having at least one first passive stabilization system based on mass inertia, which acts on the at least one first movable optical element, and at least one second passive stabilization system based on mass inertia, which acts on the at least one second movable optical element. The optical device further comprises a foldable bridge connecting the first housing and the second housing to one another. The optical device is a binocular long-range optical device.

In the binocular long-range optical device according to the invention, the movable optical elements of the first and the second optical channels are accordingly not rigidly coupled to one another, but rather movable relative to one another, and respectively a separate stabilization system for image stabilization is associated with each of these movable optical elements of the first and second channels. In this way, it is possible to implement the binocular long-range optical device according to the invention in conventional construction, i.e., in a construction which is familiar to the user of binocular long-range optical devices without image stabilization. In the binocular long-range optical device according to the invention, the two optical channels together with their housings are therefore again physically separated from one another and connected to one another by a foldable bridge as in conventional long-range optical devices without image stabilization, so that the user can adapt the binocular long-range optical device according to the invention to his eye spacing, which makes the handling easier and increases the acceptance. Furthermore, the binocular long-range optical device according to the invention has the advantage that it has a passive stabilization system based on mass inertia for each optical channel, whereby, on the one hand, the binocular long-range optical device according to the invention is lightweight and, on the other hand, it can be produced at low cost.

In the scope of the present invention, the two stabilization systems can be designed to be exclusively passive, however, hybrid stabilization systems for the two optical channels are also possible in the scope of the invention, i.e., stabilization systems which represent a combination of passive and active image stabilization.

In a preferred refinement, the at least one first movable optical element is fastened on a first carrier, which is supported on the first housing in movable manner relative to the first housing, and at least one second movable optical element is fastened on a second carrier, which is supported on the second housing in movable manner relative to the second housing, wherein the first carrier and the second carrier are movable relative to one another.

In this refinement, the at least two movable optical elements are respectively fixed on a separate carrier, which is movably mounted in the respective housing of the respective optical channel, whereby the two optical channels are constructed identically, but independently of one another, as in conventional binocular long-range optical devices. The relative mobility or the lack of rigid coupling between the first carrier and the second carrier ensures that the first housing and the second housing remain movable to one another via the foldable bridge.

In a further preferred refinement, the at least one first stabilization system generates a restoring force proportional to the displacement amplitude and/or a restoring force proportional to the displacement velocity of the first movable optical element, and the at least one second stabilization system generates a restoring force proportional to the displacement amplitude and/or a restoring force proportional to the displacement velocity of the second movable optical element.

In this refinement, the two optical channels are respectively provided with a stabilization system, which is completely passive and is based on mass inertia. A particularly cost-effective implementation of the binocular long-range optical device according to the invention is provided in this way, which can dispense with active components such as sensors, actuators, controller, and voltage supply.

In a further preferred refinement, the at least one first stabilization system has a first gimbal spring joint for the movable supporting of the at least one first movable optical element in the first housing and the at least one second stabilization system has a second gimbal spring joint for the movable supporting of the at least one second movable optical element in the second housing.

In this refinement, both movable optical elements are therefore respectively gimbal-supported per se in the respective housing of the respective optical channel, preferably around two axes perpendicular to one another, in particular a horizontal axis transverse to the longitudinal direction and the vertical axis of the binocular long-range optical device. The respective separate supporting of the respective at least one movable optical element of each optical channel via a spring joint has the advantage that such a supporting has, in contrast to plain bearings and roller bearings, a chronologically constant friction force, so that the restoring force of the spring joint remains constant in the scope of normal loads.

In a further preferred refinement, the at least one first stabilization system has a first damping unit for damping the movement of the at least one first movable optical element and the at least one second stabilization system has a second damping unit for damping the movement of the at least one second optical element.

In particular in conjunction with the above-mentioned refinement, according to which the two movable optical elements are mounted via a respective gimbal spring joint in the respective optical channel, this measure has the advantage that the damping characteristic of the respective stabilization system is nearly solely determined by the damping unit, whereby the damping characteristic of the respective stabilization system can be set in a well-defined manner.

The gimbal spring joints generate the above-mentioned restoring forces proportional to the displacement amplitude in this case, while the damping unit generates the restoring forces proportional to the displacement velocity of the respective movable optical element.

The first and the second damping units are preferably configured as eddy current dampers.

The configuration of the damping units as eddy current dampers has the advantage that the damping characteristic of the respective stabilization system can be set easily by simple measures, for example, by the spacing of the magnets or by the geometry of the eddy current plates.

As already mentioned above, the present invention is not restricted to the stabilization systems of the first optical channel and the second optical channel operating solely passively and being based on mass inertia, but rather hybrid stabilization systems are also possible. For example, in the case of the embodiment of the damping unit as an eddy current damper, it can be provided that the eddy current plates are additionally provided with one or more coils having an alignment corresponding to the degrees of freedom of the gimbal supporting, whereby the passive image stabilization is then actively assisted by measuring the perturbing movements and calculating the necessary compensation movements and applying the necessary induction voltage to the coils. Such a hybrid image stabilization system can engage not only on the damping unit, but rather also on the respective spring joint, for example, by way of actuators provided on the respective spring joint.

In a further preferred refinement, the first stabilization system and the second stabilization system have the same response behavior to the perturbing movements.

This measure has the advantage that binocular vision defects, which are caused by different images of the two optical channels, can be avoided as well as possible. In other words, the above-mentioned measure causes the first and the second stabilization system to react to perturbing movements in concordance with respect to one another.

In this context and in conjunction with the above-mentioned refinements, the restoring forces of the first and second stabilization systems proportional to the displacement amplitude and/or the restoring forces of the first and second stabilization systems proportional to the displacement velocity are adapted to one another, so that the at least one first and the at least one second movable optical elements react to the perturbing movements in phase and with equal movement amplitude.

In this refinement, the stabilization characteristics of both passive stabilization systems are therefore adapted to one another by adapting the restoring forces generated thereby, including the inertial masses, so that the stabilization systems react to an identical excitation signal with a sufficiently congruent displacement and damping and have no phase or only a minimal phase to one another in their reaction. Because of the fact that the two housings of the two optical channels are rigidly coupled to one another via the foldable bridge except the inclination adjustability, it is ensured that both stabilization systems are excited by the same perturbing movements. In the event of strongly asymmetrical excitation, a slightly unequal excitation amplitude of both stabilization systems is possible, but even then, the excitation frequencies are identical and there is no phase difference between the two.

In further conjunction with the above-mentioned refinement, it is preferable if the first stabilization system has first units for adjusting the restoring force of the first stabilization system proportional to the displacement amplitude and/or proportional to the displacement velocity and/or the second stabilization system has second units for adjusting the restoring force of the second stabilization system proportional to the displacement amplitude and/or proportional to the displacement velocity.

Even in the case of identical construction of both stabilization systems, slight deviations in the reaction of the two stabilization systems as a result of manufacturing tolerances cannot be completely precluded. Using the above-mentioned measure, however, the binocular vision defect can be minimized at least enough so that it is not perceived by the user. The units for adjustment can engage, for example, on the gimbal supports or on the damping elements of the stabilization systems. In addition, the units for adjustment can have tare masses.

In a further preferred refinement, it is provided that the first stabilization system and the second stabilization system respectively have at least one tare mass for balancing out the equilibrium position.

The use of tare masses for balancing out the equilibrium positions of the two stabilization systems of the two optical channels has the advantage that fine balancing out of the equilibrium positions can be achieved by simple handling, because the respective tare mass only has to be positioned and fastened for this purpose. The tare masses can be configured on the respective carrier of the respective movable optical element as a ring or as a mass block, for example.

The first and the second stabilization systems preferably respectively have at least two tare masses for balancing out the equilibrium position around at least two axes perpendicular to one another.

It is advantageous in this case that balancing out is made possible independently of one another around at least two axes perpendicular to one another.

In a further preferred refinement, the at least one first stabilization system and the at least one second stabilization system are not coupled to one another.

In this refinement, the two stabilization systems therefore operate completely autonomously from one another. To avoid a binocular vision defect, the above-mentioned measures are typically sufficient to ensure an identical response behavior of both stabilization systems to the perturbing movements.

According to a further preferred refinement, an operative coupling is provided between the two stabilization systems.

An “operative coupling” is not to be understood as a rigid mechanical coupling as in the prior art, but rather only a coupling of the effects of the two stabilization systems operating independently of one another.

Such an operative coupling between the two stabilization systems, which does not represent a rigid mechanical coupling, can consist, for example, of a coupling of the two stabilization systems via the restoring forces generated thereby. An operative coupling has the advantage that in the case that balancing of the reaction behavior of the two stabilization systems to one another is not completely achievable by adjustment units, such balancing can be achieved by the operative coupling and therefore the binocular vision defect can be decreased still further.

An operative coupling may be implemented easily via the damping units.

It is thus provided in a further preferred embodiment that the eddy current dampers of the two stabilization systems are coupled to one another by flexible conductors via at least one electrical resistor.

This measure has the advantage of a simple and flexible operative coupling between the two stabilization systems. The flexible conductors may be led through the foldable bridge between the two housings of the two optical channels, without impairing the mobility of the two housings via the foldable bridge relative to one another, and without rigidly coupling the movable optical elements or the carriers thereof to one another. The current generated in the eddy current dampers during movements of the two optical elements is transferred via the flexible conductors and the electrical resistor to the respective other eddy current damper, whereby both eddy current dampers are then “brought into line” in their effect.

In this case, it is furthermore preferable if the eddy current dampers each have at least one coil, and if the coils are coupled to one another via the at least one electrical resistor.

The coils can be provided additionally or alternatively to the eddy current plates typically provided in the eddy current dampers.

Each of the eddy current dampers preferably has at least two coils, which are oriented differently, to take into consideration the various degrees of freedom of the movement of the movable optical elements. It is to be ensured in this case that the coils of the two stabilization systems are connected to one another in such a manner that, for example, a horizontal excitation of one stabilization system excites the other stabilization system in the same direction.

Since the damping factor of the two stabilization systems in the case of such an operative coupling is decisively determined by the coupling resistor or the voltage which drops via this resistor, it is preferable if the resistor is settable. In this way, the damping can advantageously be variably set accordingly.

A further refinement of an operative coupling between the two stabilization systems is preferably that the first carrier and the second carrier are hydraulically coupled to one another.

This type of the operative coupling can be provided additionally or alternatively to the above-described action coupling via the damping units.

A hydraulic operative coupling of the two carriers to one another also has the advantage that the coupling is not rigid, because flexible hydraulic lines can be used.

For this purpose, according to a further preferred embodiment, the first carrier and the second carrier are each provided with at least one pressure receiver and at least one pressure generator, wherein the pressure receiver and the pressure generators have folded bellows, which are connected to one another between the first carrier and the second carrier by flexible lines.

By way of the use of folded bellows as a pressure receiver or pressure generator, respectively, this operative coupling also is, like the above-mentioned action coupling of the eddy current dampers, a passive operative coupling, which does not require an actuator system and a sensor system. The folded bellows are compressed or extended depending on the movement of the associated carrier, whereby pressure is built up or lowered, wherein this pressure build-up or pressure lowering can then be transferred via the flexible lines to the respective corresponding folded bellows of the other carrier. A displacement of the first carrier then deflects the second carrier in the same direction and by the same amount, or vice versa.

The folded bellows are preferably arranged as remotely as possible from the bearing point of the respective carrier, to thus achieve the best possible operative coupling between the two stabilization systems as a result of a longer lever.

In the case that the stabilization systems are respectively equipped with an eddy current damper, the folded bellows are positioned on the side of the gimbal supports of the two carriers facing away from the eddy current dampers.

With reference to further preferred refinements of the binocular long-range optical device according to the invention, a further aspect of the present invention will be described hereafter. It is obvious that this aspect which is still to be described can also be used alone, i.e., without the characterizing features of patent claim 1, in a binocular long-range optical device, and also in a monocular long-range optical device.

As already described above, long-range optical devices having a passive stabilization system based on mass inertia share the feature that they have at least one freely movable optical element. For multiple reasons, it can be necessary to suppress the movement freedom of this at least one movable optical element entirely, in order to thus, for example, deactivate the image stabilization or protect the stabilization system from impact damage during transport.

There are multiple possible implementations for a blocking unit required for this purpose. Thus, the possibility exists of guiding a bolt in a form-fitted opening, to block the stabilization system and therefore deactivate it. In this conventional construction, the bolt engages directly at the bearing point of the at least one movable optical element and acquires its lever action solely from its length. In this way, either the load on the blocking device is very high if a short bolt is used, or a longer bolt must be housed in the assembly, which possibly enlarges the assembly unnecessarily.

The presently known blocking devices additionally permit only the two states “image stabilization released” and “image stabilization blocked”. In the latter case, the stabilization system is fixed in a predefined position, while it is freely movable in the first case and is held by end location limiters in a predefined movement range.

Furthermore, in long-range optical devices having a passive stabilization system based on mass inertia, end position limiters for the stabilization system are necessary to avoid displacements of the movable parts beyond the load limits, impact damages, excessively large displacements, for example, in the case of resonant frequencies or poorly stabilized frequencies, or excessively large displacements which cause vision defects, and rattling noises.

The end position limiter is conventionally implemented using screws, which define the movement margin of the stabilization system laterally to the optical axis. Along the optical axis, the movement margin of the stabilization system is delimited by stops in the solid-state spring joint.

As results from the above statements, the blocking unit and the end position limiter are conventionally embodied separately from one another. In binocular long-range optical devices having active stabilization system based on an actuator system, however, a combination of blocking unit and end position limiter is already implemented.

The present aspect of the invention is therefore based on the object of providing, for a long-range optical device having passive stabilization system based on mass inertia, technically simple measures which permit the user to deactivate the image stabilization, activate it, and adapt it according to his requirements or applications.

According to a further aspect, an optical device is provided, comprising an optical channel, the optical channel having a housing and an arrangement of optical elements arranged in the housing, the arrangement having at least one optical element movable relative to the housing. The optical device further comprises at least one passive stabilization system based on mass inertia for image stabilization in the event of perturbing movements of the housing, the at least one stabilization system acting on the at least one movable optical element. The optical device further comprises at least one end position limiter unit which is settable for setting a maximum displacement of the at least one movable optical element.

Thus, at least one end position limiter unit is provided in a long-range optical device, by means of which the maximum displacement of the at least one first movable optical element and/or the maximum displacement of the at least one second movable optical element is settable.

It is therefore possible for the user, by way of the setting ability of the end position limiter, to set the maximum displacement of the at least one movable optical element and the image stabilization thus achieved according to his own preference, in particular to adapt the image stabilization optimally to the intended application.

It is furthermore preferable in this case if the maximum displacement is differently settable in two spatial directions perpendicular to one another.

In this way, the advantage is achieved that the maximum displacement can be set in a direction-selective manner.

Furthermore, it is preferable if the maximum displacement of the at least one first movable optical element and/or the maximum displacement of the at least one second movable optical element is settable continuously or in steps.

A continuous setting ability of the maximum displacement has the advantage that the user is not restricted to the setting of predefined, discrete maximum displacements. A setting ability in steps of the maximum displacement has the advantage, in contrast, that the user can become familiar more rapidly with a small finite number of setting possibilities, whereby he can retrieve the optimum maximum displacement for a specific application particularly rapidly and reproducibly.

Furthermore, it is preferable if the maximum displacement is settable to zero.

In this refinement, the end position limiter is therefore used not only to delimit the maximum displacement of the stabilization system, but rather also assumes the function of a blocking unit, in that the maximum displacement of the stabilization system is set to zero. In this way, a space-saving, structurally simple combination of end location limiter and blocking unit is provided.

In a further preferred refinement, the at least one end location limiter unit has at least one first stop for the first carrier and/or at least one second stop for the second carrier, wherein the first stop and/or the second stop is/are arranged in the longitudinal direction of the first carrier or the second carrier with spacing to the first or second spring joint, respectively.

It is advantageous in this case that due to the arrangement of the at least one stop with spacing to the spring joint of the carrier, a large lever action is achieved without a longer bolt having to be used. The structural dimensions of the stabilization system are enlarged only slightly or not at all in this way.

The at least one first and/or second stop can be arranged on the housing side and/or on the carrier side.

Furthermore, it is preferable if the first stop and/or the second stop has an elastic shock absorber.

It is advantageous in this case that, on the one hand, rattling noises are avoided and, on the other hand, hard impacts on the optical system of the binocular long-range optical device are avoided.

For example, plastic or rubber elements, elastomeric elements, or springs can be used as the elastic shock absorber, to name a few examples here.

In a further preferred embodiment, the at least one first stop and/or the at least one second stop has at least three circumferentially limited, preferably spot-shaped individual stops, which are preferably uniformly distributed circumferentially around the first carrier or the second carrier.

The implementation of the end position limiter unit by preferably spot-shaped individual stops has, on the one hand, the advantage of saving weight of the end position limiter unit, on the other hand, this refinement allows a direction-selective setting ability of the maximum displacement in a simple manner. The latter permits, in the event of excitation amplitudes deviating strongly from one another in two spatial directions perpendicular to one another, for example, in the horizontal and vertical directions, for example, in maritime application or during the observation of traveling vehicles, a better adaptation of the image stabilization to the conditions.

In a simpler embodiment in relation to the above-mentioned measure with respect to the installation expenditure, it is provided that the at least one first stop and/or the at least one second stop is implemented as a sleeve enclosing the first carrier or the second carrier, respectively.

To be able to set different maximum displacements of the stabilization system by way of the sleeve here, it is provided according to a further preferred refinement that an internal diameter of the sleeve tapers in steps or continuously in the longitudinal direction of the first carrier or the second carrier, and/or that an external contour of the first carrier or the second carrier tapers in steps or continuously, and that the sleeve is location-adjustable in the longitudinal direction of the first or second housing.

In this way, an end position limiter which is both structurally simple and also easy to operate, and is settable continuously or in steps is provided, wherein it can also assume a blocking function if sleeves or carriers are adapted to one another so that they interlock in a form-fitting manner in a predetermined axial relative position.

In another preferred refinement, the at least one first stop and/or the at least one second stop has at least one carrier-side projection which extends away from the first carrier or the second carrier, respectively, transversely to its longitudinal direction and at least one jaw arranged on the housing side and extending transversely to the longitudinal direction, which is spaced apart in the longitudinal direction from the carrier-side projection.

The effect of the end position limiter unit produced in this way for delimiting the maximum displacement of the stabilization system is provided here in that the carrier-side projection, which describes a path in the form of a partial circle in the event of a displacement of the carrier around the bearing point, runs with its outer end against the housing-side jaw.

To obtain a setting ability of the maximum displacement of the stabilization system here, the spacing from one another between projection and jaws is preferably settable.

Furthermore, it is preferable if two housing-side jaws are arranged on both sides of the carrier-side projection, whereby the carrier-side projection is enclosed between the two housing-side jaws and comes into contact depending on the movement direction with one or the other housing-side jaw to delimit the maximum displacement.

For this purpose, it is furthermore preferably provided that the spacing of the two housing-side jaws from one another is settable to obtain a setting ability of the maximum displacement. The end location limiter unit can also act as a blocking unit in this embodiment via minimization of the spacing of the jaws.

The above-mentioned elastic shock absorber can also be implemented here in that at least one of the above-mentioned projections is implemented as a leaf spring.

Further advantages and features result from the following description and the appended drawings.

It is to be understood that the above-mentioned features and the features still to be explained hereafter are usable not only in the respective specified combination, but rather also in other combinations or alone, without leaving the scope of the present invention.

### BRIEF DESCRIPTION OF THE DRAWINGS

Exemplary embodiments of the invention are illustrated in the drawings and will be described in greater detail hereafter with reference thereto. In the drawings:

FIG. 1 shows a schematic illustration of a binocular long-range optical device according to the present invention in a top view;

FIG. 2 shows a schematic illustration of an exemplary embodiment of a binocular long-range optical device according to the invention in a top view;

FIG. 2A shows a detail of the binocular long-range optical device according to FIG. 2 in a front view;

FIG. 3 shows a refinement of the binocular long-range optical device in FIG. 2;

FIG. 4 shows a further refinement of the binocular long-range optical device in FIG. 2;

FIG. 5 shows a detail of the binocular device in FIG. 4 in a front view;

FIG. 6 shows still a further refinement of the binocular long-range optical device in FIG. 2, wherein FIG. 6 only shows one of the two optical channels of the binocular long-range optical device;

FIG. 7 shows a portion of a long-range optical device in longitudinal section according to an exemplary embodiment of a further aspect of the present invention, which relates to an end position limiter unit for a passive stabilization system;

FIG. 8 shows a further exemplary embodiment of the aspect according to FIG. 7;

FIG. 9 shows a schematic illustration of an alternative embodiment of the aspect according to FIGS. 7 and 8.

### DESCRIPTION OF PREFERRED EXEMPLARY EMBODIMENTS

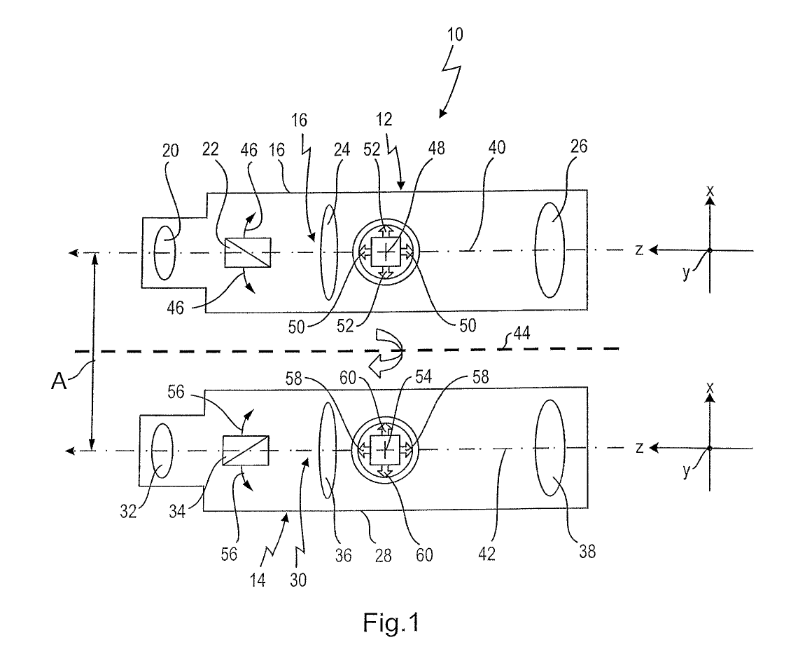

FIG. 1 shows a schematic illustration of a binocular long-range optical device, which is provided with the general reference sign 10. The binocular long-range optical device is embodied as a pair of binoculars.

The binocular long-range optical device has a first optical channel 12 and a second optical channel 14.

The first optical channel 12 has a first housing 16, in which a first arrangement 18 of first optical elements 20, 22, 24, and 26 is arranged. In this case, the optical element 20 is an eyepiece, the optical element 22 is an image inversion prism, the optical element 24 is a focusing optic, and the optical element 26 is an objective of the first optical channel 12.

The second optical channel 14 has a second housing 28, in which a second optical arrangement 30 of second optical elements 32, 34, 36, 38 is arranged. The optical element 32 is an eyepiece, the optical element 34 is an image inversion prism, the optical element 36 is a focusing optic, and the optical element 38 is an objective of the second optical channel 14.

The first arrangement 18 defines an optical axis 40 and the second arrangement 30 defines an optical axis 42.

The first optical arrangement 18 and the second optical arrangement 30 are constructed identically to one another.

Both for the first optical channel 12 and also for the second optical channel 14, in FIG. 1, respectively a coordinate system fixed on the optical channel is shown for easier understanding of the following description. In this coordinate system, the respective z-axis indicates the respective longitudinal direction or the optical axis 40, 42 of the first optical channel 12 or of the second optical channel 14, respectively. The respective x-axis indicates the horizontal axis of the first optical channel 12 or the second optical channel 14, respectively, which extends perpendicularly to the z-axis. The respective y-axis is the respective vertical axis of the optical channel 12 or of the optical channel 14, which extends perpendicularly to both the x-axis and also the z-axis and is perpendicular to the plane of the drawing in the illustration in FIG. 1.

The first housing 16 and the second housing 28 are connected to one another via a foldable bridge 44 shown by an interrupted line, as is also typically the case in conventional binoculars without image stabilization, to be able to adapt a spacing A of the two eyepieces 20 and 32 from one another to the eye spacing of the user. Via the foldable bridge 44, the first housing 16 and the second housing 28 may be pivoted relative to one another around an axis of rotation (interrupted line in FIG. 1), which extends parallel to the z-axes of the optical channels 12 and 14, whereby the spacing A can be made larger or smaller.

Space-saving tetrahedral reflection prisms, for example, Schmidt-Pechan prisms, can be used as the image inversion prisms 22 and 34. In this case, the image inversion prisms 22 and 34 are implemented as direct vision prisms, as shown in FIG. 1. In the case that the binocular long-range optical device 10 has large diameters of the objectives 26 and 38, so that under certain circumstances the spacing A can no longer be adapted to a small eye spacing solely by the foldable bridge 44, other prism types can also be used for the image inversion prisms 22 and 34, specifically those which cause a beam offset toward the foldable bridge 44 and are nonetheless space-saving. These prism types include, for example, Abbe-König prisms.

The binocular long-range optical device 10 is equipped, as described hereafter, with image stabilization against perturbing movements, which can act on the first housing 16 and the second housing 28, for example, trembling hands during freehand usage of the binocular long-range optical device 10 and/or perturbing movements, which can be caused by moving grounds, for example, during the usage of the binocular long-range optical device 10 in vehicles in motion. Such perturbing movements can be expressed in shaking of the image generated by the optical elements 20, 22, 24, 26 and 32, 34, 36, 38, which is undesirable. The image stabilization, in contrast, removes shaking of the image or at least decreases it.

For the image stabilization, at least one of the first optical elements 20, 22, 24, and 26 and at least one of the second optical elements 32, 34, 36, and 38 in each of the two optical channels 12 and 14 is supported in the associated housing 16 or 28, respectively, movably relative to the respective housing 16 and 28. In the present case, the image inversion prism 22 is supported movably in the first housing 16 in the first optical channel 12 and the image inversion prism 34 is supported movably in the second housing 28 in the second optical channel 14.

The image inversion prism 22 is supported pivotably in this case around the y-axis, as indicated using arrows 46, and around the x-axis. The possible pivot movements of the image inversion prism 22 around the x-axis and around the y-axis occur around a geometrical rotation or bearing point 48, which is located on the optical axis 40 in the center point between the main planes of the eyepiece 20 and the objective 26. Arrows 50 illustrate the mobility of the image inversion prism 22 around the x-axis and arrows 52 illustrate the mobility of the image inversion prism 22 around the y-axis. The image inversion prism 22 is therefore gimbal-supported, and can execute movements in relation to the housing 16, which are oriented in the horizontal direction (transversely to the axis) and/or in the vertical direction and also those which represent super positions of these two main movement directions.

In the same way, in the second optical channel 14, the image inversion prism 34 is pivotably supported in the second housing 28 around a geometrical rotation or bearing point 54 both around the y-axis (according to arrows 56) and also around the x-axis. The rotation or bearing point 54 is located on the optical axis 42 in the center point between the main planes of the eyepiece 32 and the objective 38. Arrows 58 indicate in this case the possible movements around the x-axis and arrows 60 indicate the possible movements around the y-axis.

The two image inversion prisms 22 and 34 are not only movable relative to the respective associated housing 16 or 28, but rather also relative to one another. In the binocular long-range optical device according to DE 38 43 776 Al, the two image inversion prisms are rigidly coupled to one another, in contrast. The relative mobility to one another is achieved in the image inversion prisms 22 and 34 in that both have a separate bearing point (rotation or bearing point 48 and rotation or bearing point 54).

For the image stabilization, furthermore, a first passive stabilization system based on mass inertia is associated with the image inversion prism 22, and a second passive stabilization system based on mass inertia is associated with the image inversion prism 34, as described hereafter. In this case, the first passive stabilization system acts on the image inversion prism 22, and the second passive stabilization system acts on the image inversion prism 34.

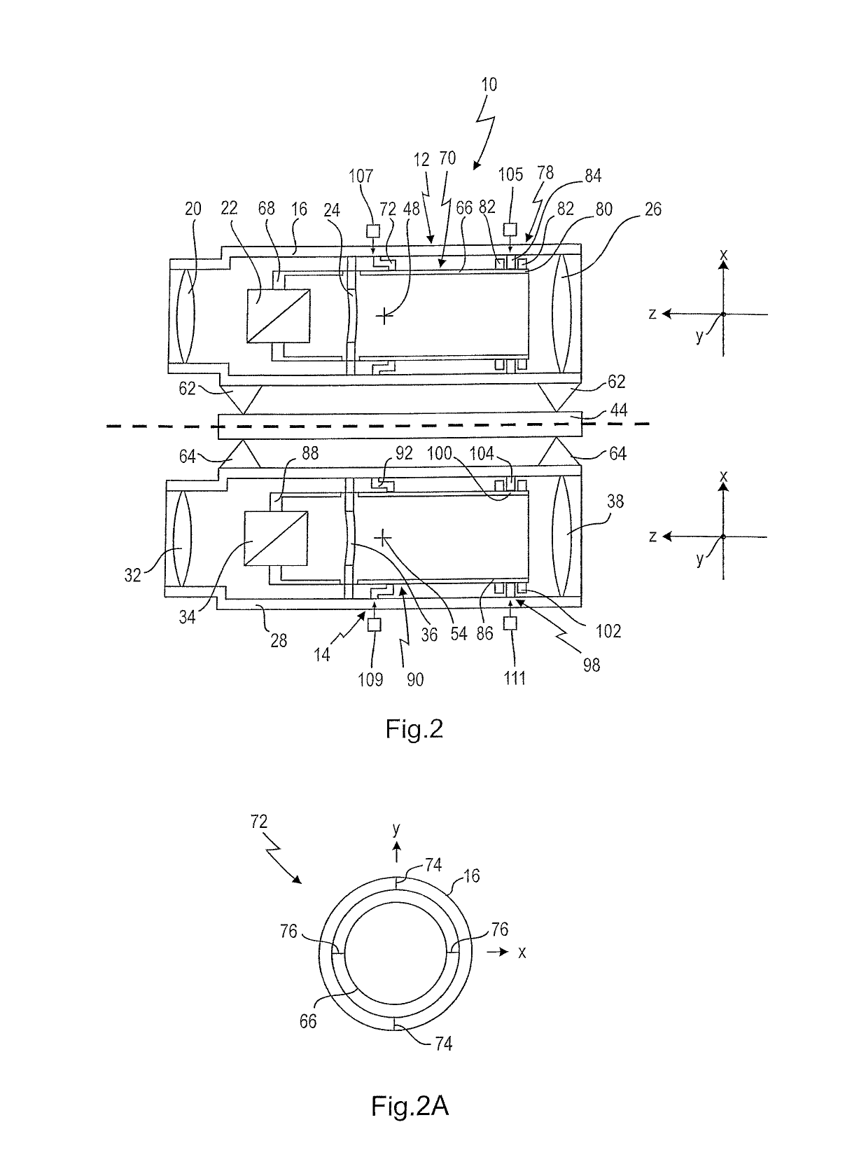

With reference to FIGS. 2 and 2A, a possible implementation of the first and second passive stabilization systems will now be described on the basis of an exemplary embodiment. In FIGS. 2 and 2A, those elements which are identical or comparable to corresponding elements in FIG. 1 are provided with the same reference signs as in FIG. 1.

In addition to FIG. 1, in FIG. 2 firstly the foldable bridge 44 and connecting parts 62 for connecting the first housing 16 to the foldable bridge 44 and connecting parts 64 for connecting the second housing 28 to the foldable bridge 44 are schematically shown.

The image inversion prism 22 in the first optical channel 12 is fastened on a first carrier 66. The first carrier 66 is embodied as a substantially cylindrical tube. The image inversion prism 22 is fastened on a first end 68 of the carrier 66. The focusing optic 24, in contrast, is not fixed on the carrier 66, but rather is fixed on the first housing 16.

A first passive stabilization system 70 based on mass inertia is associated with the image inversion prism 22 or the carrier 66. The first passive stabilization system 70 has a gimbal spring joint 72, which is embodied as a torsion spring joint. FIG. 2A shows the gimbal spring joint 72 in a front view alone. Corresponding to the rotational degrees of freedom around the y-axis and the x-axis, the spring joint 72 has springs 74 and 76, via which the carrier 66 and therefore the image inversion prism 22 are pivotably mounted around the geometric rotation or bearing point 48.

The spring joint 72 generates, in the event of a displacement of the image inversion prism 22 relative to the first housing 16, a restoring force proportional to the displacement amplitude.

The first passive stabilization system 70 furthermore has a damping unit 78, which is arranged on a second end 80 of the carrier 66. The damping unit 78 causes a restoring force proportional to the displacement velocity of the displacement of the image inversion prism 22. The damping unit 78 is implemented as an eddy current damper and has carrier-fixed magnets 82 and a housing-fixed eddy current plate 84.

The image inversion prism 34 of the second optical channel 14 is fastened in the second housing 28 on a second carrier 86 in a similar way at a first end 88.

A second passive stabilization system 90 based on mass inertia has a gimbal spring joint 92 for the movable mounting of the second carrier 86, which is implemented in the same manner as the gimbal spring joint 72 of the first optical channel 12.

The second passive stabilization system 90 furthermore has a damping unit 98, which is arranged on a second end 100 of the second carrier 86 and is implemented as an eddy current damper. Correspondingly, the damping unit 98 has magnets 102, which are fastened on the second carrier 86, and an eddy current plate 104, which is fastened on the second housing 28.

The spring joint 92 generates a restoring force proportional to the displacement amplitude of the image inversion prism 34, and the damping unit 98 generates a restoring force proportional to the displacement velocity of the displacement of the image inversion prism 34.

In the exemplary embodiment shown, the two stabilization systems 70 and 90 are exclusively passive and are based on mass inertia. However, it is also possible to embody the stabilization systems 70 and 90 as hybrid stabilization systems. This can be implemented, for example, in that the eddy current plates 84, 104 are additionally equipped with one or more coils (in the x- and y-directions). By measuring the perturbing movements, calculating the required compensation movements, and applying the required induction voltage to these coils, the passive image stabilization can then be actively assisted. Alternatively or additionally, actuators can also be attached to the spring joints 72 or 92, to actively assist the movement of the spring joints 72 or 92, respectively.

In the exemplary embodiment shown, the two passive stabilization systems 70 and 90 operate completely independently of one another. Nonetheless, both stabilization systems 70 and 90 must react to an identical excitation signal, i.e., to an identical interfering movement with a sufficiently coinciding displacement and damping. The displacements of the image prism 22 and the image prism 34 caused by the same perturbing movement must be in phase with one another and occur with equal amplitude and in the same direction, to avoid a binocular vision defect.

Therefore, the two stabilization systems 70 and 90 have the same response behavior to identical perturbing movements.

Against this background, the two stabilization systems 70 and 90, including the image inversion prisms 22 and 34 and the carriers 66 and 86, are to be designed as identically as possible to one another.

Since the two housings 16 and 28 are rigidly connected to one another via the foldable bridge 44 except for their relative inclination adjustment around the open bridge 44, it is ensured that both stabilization systems 70 and 90 are excited by the same perturbing movements. In the event of a strongly asymmetrical excitation of the first housing 16 relative to the second housing 28, a slightly unequal excitation amplitude of both stabilization systems 70 and 90 is possible, but even then the excitation frequencies are identical and there is no phase difference between them.

Even in the event of identical construction of the stabilization systems 70 and 90 including the image inversion prisms 22, 34 and the carriers 66 and 86, however, it cannot be precluded, as a result of manufacturing tolerances, that the two stabilization systems 70 and 90 will display slight deviations in the reaction thereof to identical perturbing movements.

Against this background, the movable inertial masses and the restoring forces of the first and second stabilization systems 70, 90 proportional to the displacement amplitude and/or the restoring forces of the first and second stabilization systems 70, 90 proportional to the displacement velocity of the displacement of the image alignment prisms 22 or 34, respectively, must be adapted to one another, so that the image alignment prism 22 and the image alignment prism 34 react to the perturbing movements in phase with equal movement amplitude.

For this purpose, the first stabilization system 70 and the second stabilization system 90 have units 105, 107, 109, and/or 111 for adjusting the above-mentioned restoring forces. Such units 105, 107, 109, and 111 for adjustment can be provided, for example, on the damping units 78 and 98 and/or on the spring joints 72 and 92. Furthermore, those units which have one or more tare masses can also be provided for adjustment, to set or adapt to one another the equilibrium position of the respective stabilization system 70 or 90. This will be described in greater detail hereafter.

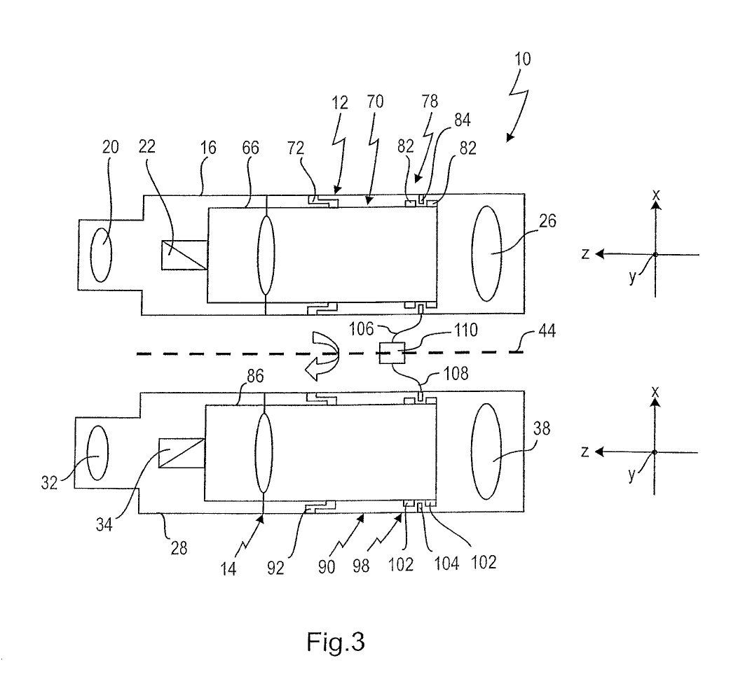

In spite of minimization of all manufacturing tolerances of the individual components of the long-range optical device 10 and in spite of provision of adjustment possibilities for adapting the two stabilization systems 70 and 90 for identical response behavior to perturbing movements, it can be useful, to reduce or even avoid a binocular vision defect, to couple the two stabilization systems 70 and 90 to one another with respect to effect. Exemplary embodiments thereof will be described with reference to FIGS. 3 to 5.

FIG. 3 shows an exemplary embodiment of the binocular long-range optical device 10, wherein elements which are identical or comparable with elements in FIG. 2 are provided with the same reference signs in FIG. 3.

FIG. 3 shows the case of an operative coupling of the two stabilization systems 70 and 90 to one another via the restoring forces proportional to the displacement velocity.

In this case, the damping units 78 and 98, which are both implemented as eddy current dampers, are coupled to one another.

This can be performed in that the eddy current plates 84 and 104 are coupled to one another by flexible electrical conductors 106 and 108 and by one or more resistors 110. Alternatively or additionally to the eddy current plates 84 and 104, the eddy current dampers can each have at least one coil (not shown) having an alignment of the coil axis in the direction of the y-axis and at least one coil (not shown) having an alignment of the coil axis in the direction of the x-axis. By resistance coupling of these coils of the two stabilization systems 70 and 90, an operative coupling of the damping constants of the two optical channels 12 and 14 is implemented. In the case of this type of the operative coupling between the two stabilization systems 70 and 90, it is to be ensured that the damping units 78 and 98 are connected to one another via the resistor or the resistors 110 such that, for example, in the event of a displacement of the image inversion prism 22 in a specific direction, the image inversion prism 34 is also deflected in precisely the same direction.

The relative mobility of the housings 16 and 28 via the foldable bridge 44 is not impaired in any way due to the use of sufficiently long flexible lines 106 and 108.

In the case of this type of the operative coupling, the damping (restoring force proportional to the displacement velocity) is decisively determined by the coupling resistor or resistors 110. The resistor 110 or the resistors 110 is/are preferably settable, to thus be able to set the damping.

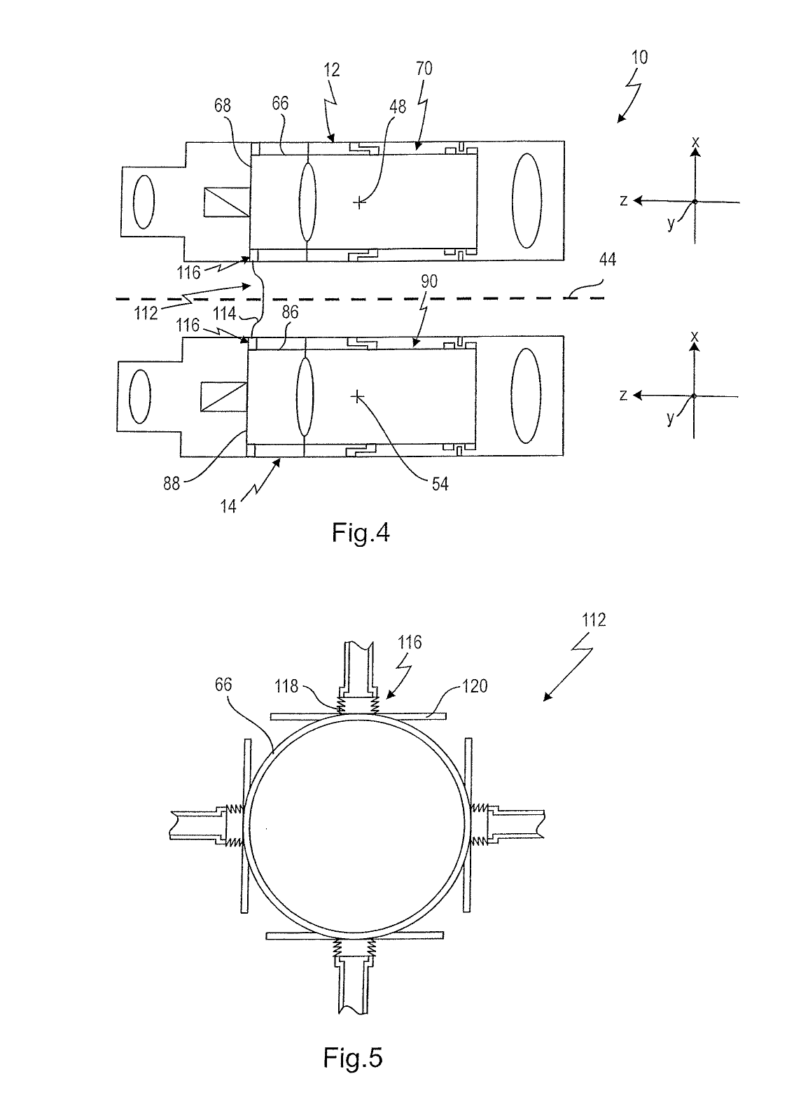

Alternatively or additionally to the action coupling of the two stabilization systems 70 and 90 shown in FIG. 3, a hydraulic action coupling of the two stabilization systems 70 and 90 is shown in FIGS. 4 and 5. Elements which are identical or comparable to elements in FIGS. 2 and 3 are again provided with the same reference signs in FIGS. 4 and 5 as in FIGS. 2 and 3.

In the exemplary embodiment according to FIG. 4, the first stabilization system 70 is effect-coupled to the second stabilization system 90 via a hydraulic unit 112.

The hydraulic unit 112 connects the first carrier 66 to the second carrier 86 via one or more flexible hydraulic lines 114.

FIG. 5 shows the hydraulic unit 112 in the region of its attachment to the first carrier 66. An attachment identical thereto of the hydraulic unit 112 exists to the second carrier 86, so only the attachment to the first carrier 66 will be described.

As shown in FIG. 5, the hydraulic unit 112 has four pressure receivers/pressure generators 116, which are arranged offset to one another by 90° circumferentially on the first carrier 66, and which are each implemented as a folded bellows 118. Each folded bellows 118 acts as a pressure receiver and as a pressure generator 116. In order that the pressure receivers/pressure generators also respond to diagonal displacements, i.e., to displacements which are a superposition of a displacement around the y-axis and around the x-axis, planar attachments 120 are fastened on the first carrier 66. Depending on the displacement of the first carrier 66, individual ones of the folded bellows 118 are compressed or extended, whereby the respective folded bellows causes a pressure increase or a pressure reduction, which is transferred via the flexible line 114 to the corresponding folded bellows 118 of the second carrier 86 and received thereby. This is also true for the reverse case of the transfer of pressures from the second carrier 86 to the first carrier 66. The folded bellows 118 are connected to one another so that the displacement of the first carrier 66 deflects the second carrier 86 in the same direction and by the same amount and vice versa.

To design this type of the operative coupling between the stabilization systems 70 and 90 particularly effectively, the largest possible displacements are necessary. Therefore, the hydraulic unit 112 is arranged as remotely as possible from the respective geometrical rotation or bearing point 48 or 54, respectively, on the carriers 66 and 86, in the exemplary embodiment shown, the hydraulic unit 112 is arranged on the first end 68 of the first carrier 66 and on the first end 88 of the second carrier 86, since the other ends are occupied by the damping units 78, 98.

Since in this type of the operative coupling, flexible lines 114 are used between the two optical channels 12 and 14, they do not impair the relative inclination setting of the two optical channels 12 and 14 by means of the foldable bridge 44.

As already described above, it is significant, to avoid a binocular vision defect, that the two stabilization systems 70 and 90 in the two optical channels 12 and 14 must be adapted to one another in their response behavior to perturbing movements, in particular if, in contrast to the exemplary embodiments according to FIGS. 3 to 5, no operative coupling is provided between the two. An essential aspect of this mutual adaptation is the balancing out of the equilibrium position or the taring of the movable inertial masses of each of the two stabilization systems 70 and 90.

Both stabilization systems 70 and 90 are subject to gravity during the use of the long-range optical device 10. It must therefore be ensured that the two stabilization systems 70 and 90 are balanced out independently of the orientation of the long-range optical device 10, so that the stabilization systems 70 and 90 do not tilt, in particular do not tilt relative to one another.

In particular in the present case, that both optical channels 12 and 14 are provided with respective image stabilizations operating independently of one another, different equilibrium position must not result for the two stabilization systems 70 and 90. As a result of manufacturing tolerances, the two stabilization systems 70 and 90 cannot be produced exactly identically, however, so that an additional taring of the respective equilibrium position and adaptation of the two equilibrium positions of the two stabilization systems 70 and 90 to one another becomes necessary.

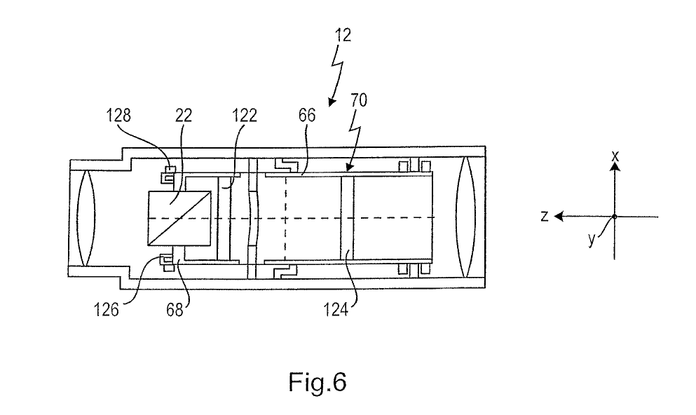

With reference to FIG. 6, an exemplary embodiment of such a taring for the optical channel 12 will be described, wherein the same taring is also provided in the optical channel 14.

Since the assembly of image alignment prism 22 and first carrier 66 has the greatest extension in the direction of the z-axis, its taring along the z-axis is of particular significance. In the case of terrestrial use (horizontal attitude of the long-range optical device 10), the long-range optical device must not tilt around the x-axis in FIG. 6 (under the assumption that no perturbing movements act on the long-range optical device 10), and in the case of astronomical use (nearly vertical attitude of the long-range optical device 10), tilting around the y-axis must be avoided. In addition, in both cases, balancing of the mass distribution must be performed along the x- and/or y-axes. To balance out the assembly of the image inversion prism 22 and the carrier 66, firstly the individual parts of the assembly are designed so that the assembly is located as close as possible to the balanced state. In the next step, only manufacturing tolerances and possible slight differences in the mass distribution must still be compensated for, which give rise to torques due to gravity. These torques are remedied by position-adjustable tare masses.

To balance the mass distribution in the direction of the z-axis, tare masses 122, 124, which are displaceable in the direction of the z-axis, are arranged for this purpose on the carrier 66, these masses being arranged in the form of narrow rings on the inner side or outer side of the carrier 66.

To balance out the mass distribution in the direction of the x-axis and the y-axis, recesses 126 and tare masses 128 matching thereto are provided on the first end 68 perpendicularly to the corresponding axis, around which a tilting torque is to be avoided.

After all tare masses have been positioned, they are also permanently fixed, for example, by means of clamping screws, by adhesive, or solely by friction, for example, a rubber coating on the friction surfaces, whereby the friction can also be strengthened by threads.

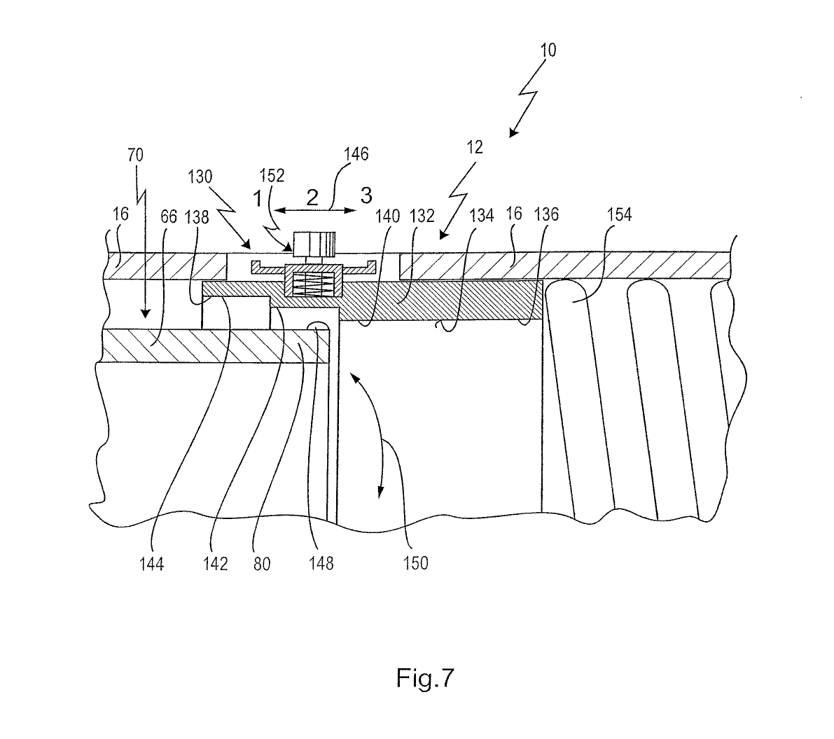

A further aspect of the present invention will be described hereafter on the basis of exemplary embodiments with reference to FIGS. 7 to 9. The exemplary embodiments to be described hereafter may be applied in general in long-range optical devices having image stabilization, and specifically both in monocular long-range optical devices and also in binocular long-range optical devices. In addition, the exemplary embodiments to be described hereafter can be combined with the above-described embodiments of the binocular long-range optical device 10. Without restriction of the generality, therefore, those elements in FIGS. 7 to 9 which are identical or comparable to elements of the binocular long-range optical device 10 according to one or more of the embodiments of FIGS. 1 to 6 are provided with the same reference signs.

FIG. 7 shows a portion of the first optical channel 12 of the binocular long-range optical device 10. In FIG. 7, a portion of the housing 16 and the carrier 66 are accordingly shown in the region of its second end 80.

According to the present aspect, the binocular long-range optical device 10 has an end position limiter unit 130, by means of which the maximum displacement of the carrier 66 and therefore the image inversion prism 22 (not shown in FIG. 7) is settable. A corresponding end position limiter unit 130 is preferably also provided for the second optical channel 14, which can be designed identically to the end position limiter unit 130 of the first optical channel 12, so that hereafter only the end position limiter unit 130 of the first optical channel 12 will be described.

The end position limiter unit 130 has a housing-side stop 132 for the first carrier 66.

The stop 132 is implemented in the form of a cylindrical sleeve, the inner wall 134 of which tapers in steps between a first end 136 and a second end 138. In the exemplary embodiment shown, a total of three steps 140, 142, 144 are provided, so that the inner wall 134 of the stop 132 has three axially successive different internal diameters.

The stop 132 is position-adjustable in the longitudinal direction according to a double arrow 146.

The end 80 of the carrier 66 has an elastic shock absorber 148. The elastic shock absorber 148 is formed here as a ring enclosing the end 80 of the carrier 66, made of an elastic material, for example, an elastomeric material. However, circumferentially distributed individual elastic shock absorbers can also be provided. Furthermore, additionally or alternatively, the inner wall 134 of the stop 132 can be provided with one or more elastic shock absorbers.

In the event of a displacement of the carrier 66 according to a double arrow 150, the elastic shock absorber 148 comes into contact against the inner wall 134 of the stop 132, whereby the maximum displacement of the carrier 66 and therefore of the image alignment prism 22 is defined.

For the stop 132, in the exemplary embodiment shown, three different defined axial positions 1, 2, and 3 are provided, in which the stop 132 can be positioned and locked via a positioning and locking mechanism 152. The positioning and locking mechanism 152 is implemented here in the form of a catch which can be disengaged.

In FIG. 7, the stop 132 is locked in a middle position (position 2), in which the carrier 66 can be deflected by the spacing between the external circumference of the elastic shock absorber 148 and the internal diameter of the step 142.

If the stop 132 is adjusted into the position 1, the first step 140 and the elastic shock absorber 148 oppose one another. The outer diameter of the elastic shock absorber 148 and the internal diameter of the step 140 are selected so that they are essentially equal. If the stop 132 is in the position 1, the carrier 66 therefore can no longer be deflected from its idle position shown in FIG. 7. In the position 1, the end position limiter unit 130 therefore acts as a blocking unit, which limits the maximum displacement of the carrier 66 to zero. In other words, the stabilization system 70 is deactivated in the position 1.

In contrast, if the stop 132 is adjusted into the position 3, the carrier 66 can be deflected corresponding to the spacing between the elastic shock absorber 148 and the step 144, wherein only the maximum displacement of the carrier 66 is greater than in the position 2 of the stop 132. In the position 3, the stabilization system 70 is “completely” activated, in the position 2, the stabilization system 70 is “semi” activated.

For the stop 132, a restoring spring 154 is provided, which pre-tensions the stop 132 in the position 1 (blocking position).

Instead of a stepped implementation of the stop 132, it can also be embodied so that the inner wall 134 continuously tapers between the first end 136 and the second end 138. It is also possible to embody the inner wall 134 of the stop 132 continuously having equal internal diameter, and instead to provide the carrier 66 with a stepped or continuously tapering external diameter.

If the stop 132 and/or the carrier 66 has/have a continuously tapering internal or external contour, it is advantageous if the positioning and locking mechanism 152 may be continuously adjusted, whereby the maximum displacement of the image inversion prism 22 or the carrier 66 is continuously settable.

The mechanical load on the end position limiter 130 is small due to the arrangement of the end position limiter unit 130 on one end of the carrier 66, here on the end 80 of the carrier 66.

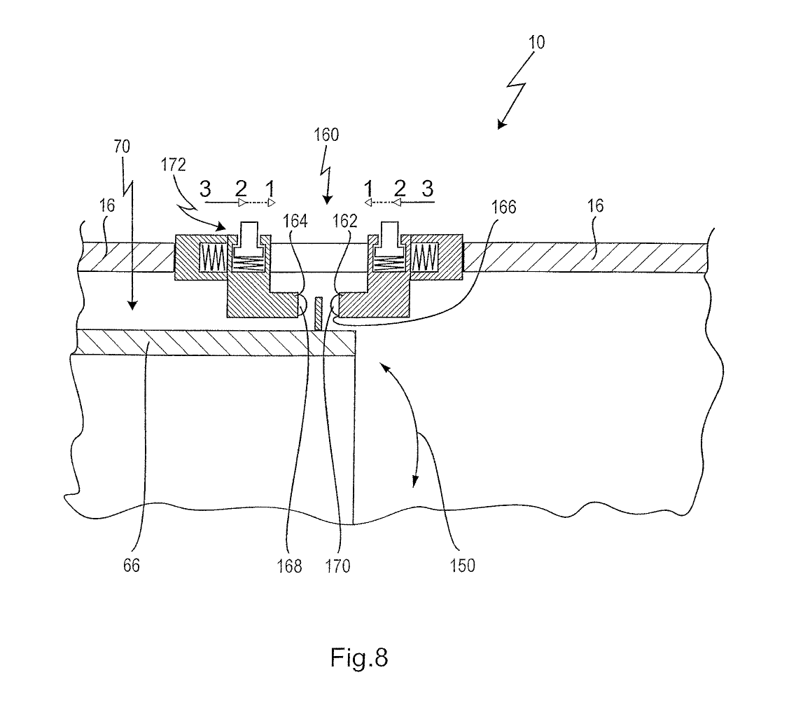

A further exemplary embodiment of an end position limiter unit 160 is shown for the binocular long-range optical device 10 in FIG. 8.

The end position limiter unit 160 has a carrier-side stop 162 here in the form of a projection extending transversely to the longitudinal direction of the carrier 66, which can be implemented, for example, as a thin plate, in particular as a spring plate.

The end position limiter unit 160 furthermore has two housing-side jaws 164, 166, which extend transversely to the longitudinal direction of the housing 16, and are laterally provided with elastic shock absorbers 168, 170. The spacings between the shock absorbers 168, 170 and therefore also the spacing between the respective shock absorber 168, 170 and the projection 162 may be varied via a positioning and locking mechanism 172. The two jaws 164, 162 can be moved uniformly toward one another and away from one another by a suitable forced guide.

In the event of a displacement of the carrier 66 according to the double arrow 150, the projection 162 executes a movement in the form of a circular arc and comes into contact with the shock absorber 168 or with the shock absorber 170, whereby the maximum displacement of the carrier 66 and therefore of the image inversion prism 22 is defined.

It can also again be provided here that the stops 164 and 166 can be positioned and locked in three discrete positions 1, 2, 3, wherein the position 1 limits the maximum displacement of the carrier 66 to zero. In the position 1 (spacing between the shock absorbers 168 and 170 is equal to the thickness of the projection 162), the end location limiter unit 160 therefore acts as a blocking unit, which deactivates the stabilization system 70. In the position 3, the maximum displacement of the carrier 66 is greatest, and in the position 2, the maximum displacement of the carrier 66 is different from zero, but is decreased in relation to the position 3.

A continuous setting of the maximum displacement can also be provided in this embodiment variant, in which instead of the three discrete positions 1, 2, and 3, the stops 164 and 166 can be continuously set and locked in their position.

In the exemplary embodiments according to FIGS. 7 and 8, the end position limiter units 130 and 160 act identically in all spatial directions of the displacement of the carrier 66.

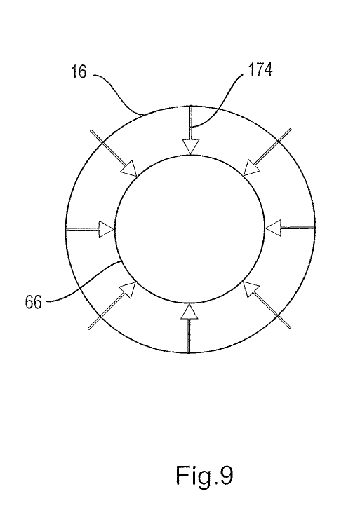

However, it is also possible to design the end position limiter unit so that the maximum displacement of the carrier 66 is settable differently in different spatial directions. This is implemented, for example, in that the end position limiter unit, as illustrated with arrows 174 in FIG. 9, has a plurality of, but at least three circumferentially limited spot-shaped individual stops, which are distributed circumferentially uniformly around the first carrier 66. In order that the end position limiter unit can also act as a blocking unit, at least three such individual stops are necessary. However, for the end position limiter function, more than three individual stops are to be provided for an optimum function, since otherwise large variations of the maximum displacement of the carrier 66 occur, depending on whether the displacement occurs in the direction toward one individual stop or in the direction toward a position between two individual stops.

The maximum displacement of the carrier 66 can be set differently in different spatial directions by an individual setting of the individual stops.

The limiting of the maximum displacement is dependent on the shape of the carrier 66 and the number and distribution of the individual stops around the carrier 66.

What is claimed is:

1. An optical device, comprising
a first optical channel, the first optical channel having a first housing and a first arrangement of first optical elements arranged in the first housing, the first arrangement having at least one first optical element movable relative to the first housing,
a second optical channel, the second optical channel having a second housing and a second arrangement of second optical elements arranged in the second housing, the second arrangement having at least one second optical element movable relative to the second housing,
the at least one first movable optical element and the at least one second movable optical element being movable relative to one another,
at least one passive stabilization system based on mass inertia for image stabilization in the event of perturbing movements of the first and second housings, the at least one stabilization system having
at least one first passive stabilization system based on mass inertia, which acts on the at least one first movable optical element, and
at least one second passive stabilization system based on mass inertia, which acts on the at least one second movable optical element,
a foldable bridge connecting the first housing and the second housing to one another, and
the optical device being a binocular long-range optical device.

2. The optical device of claim 1, further comprising
a first carrier supported in the first housing in movable manner relative to the first housing, the at least one first movable optical element being fastened on the first carrier,
a second carrier supported in the second housing in movable manner relative to the second housing, the at least one second movable optical element being fastened on the second carrier,
the first carrier and the second carrier being movable relative to one another.

3. The optical device of claim 1, wherein the at least one first stabilization system generates at least one of a restoring force proportional to the displacement amplitude and a restoring force proportional to the displacement velocity of the first movable optical element, and the at least one second stabilization system generates at least one of a restoring force proportional to the displacement amplitude and a restoring force proportional to the displacement velocity of the second movable optical element.

4. The device of claim 1, wherein the at least one first stabilization system has a first gimbal spring joint for movably supporting the at least one first movable optical element in the first housing, and the at least one second stabilization system has a second gimbal spring joint for movably supporting the at least one second movable optical element in the second housing.

5. The device of claim 1, wherein the at least one first stabilization system has a first damping unit for damping a movement of the at least one first movable optical element, and the at least one second stabilization system has a second damping unit for damping a movement of the at least one second optical element.

6. The device of claim 5, wherein the first and the second damping units are eddy current dampers.

7. The device of claim 1, wherein the at least one first stabilization system and the at least one second stabilization system have an identical response behavior to the perturbing movements.

8. The device of claim 3, wherein the at least one of the restoring forces of the first and second stabilization systems proportional to the displacement amplitude and the restoring forces of the first and second stabilization systems proportional to the displacement velocity are adapted to one another such that the at least one first and the at least one second movable optical elements react to the perturbing movements in phase and with equal movement amplitude.

9. The device of claim 3, wherein the first stabilization system has first units for adjusting the at least one of the restoring force of the first stabilization system proportional to the displacement amplitude and the restoring force proportional to the displacement velocity, and the second stabilization system has second units for adjusting the at least one of the restoring force of the second stabilization system proportional to the displacement amplitude and the restoring force proportional to the displacement velocity.

10. The device of claim 1, wherein the at least one first stabilization system and the at least one second stabilization system respectively have at least one tare mass for balancing out an equilibrium position.

11. The device of claim 1, wherein the at least one first and the at least one second stabilization systems respectively have at least two tare masses for balancing out an equilibrium position about at least two axes perpendicular to one another.

12. The device of claim 1, wherein the at least one first stabilization system and the at least one second stabilization system are independent from one another.

13. The device of claim 1, wherein the at least one first stabilization system and the at least one second stabilization system are operatively coupled to one another.

14. The device of claim 6, characterized in that the eddy current dampers are coupled to one another by flexible conductors via at least one electrical resistor.

15. The device of claim 14, characterized in that the eddy current dampers each have at least one coil, and the coils are coupled to one another via the at least one electrical resistor.

16. The device of claim 13, characterized in that the resistor is settable.

17. The device of claim 2, wherein the first carrier and the second carrier are hydraulically coupled to one another.

18. The device of claim 17, wherein the first carrier and the second carrier are each provided with at least one pressure receiver and at least one pressure generator, wherein the pressure receivers and pressure generators have folded bellows, which are connected to one another between the first carrier and the second carrier by flexible lines.

19. An optical device, comprising
an optical channel, the optical channel having a housing and an arrangement of optical elements arranged in the housing, the arrangement having at least one optical element movable relative to the housing,
at least one passive stabilization system based on mass inertia for image stabilization in the event of perturbing movements of the housing, the at least one stabilization system acting on the at least one movable optical element,
at least one end position limiter unit which is settable for setting a maximum displacement of the at least one movable optical element.

20. The device of claim 19, wherein the maximum displacement is differently settable in two spatial directions perpendicular to one another.

21. The device of claim 19, wherein the maximum displacement of the at least one movable optical element is settable continuously or in steps.

22. The device of claim 19, wherein the maximum displacement is settable to zero.

23. The device of claim 19, further comprising
a carrier supported in the housing in movable manner relative to the housing, the at least one movable optical element being fastened on the carrier, the carrier having a longitudinal dimension,
the at least one first stabilization system having a spring joint for movably supporting the carrier in the housing,
the at least one end position limiter unit having at least one stop for the carrier, the stop being arranged in the longitudinal dimension of the carrier in a distance from the spring joint.

24. The device of claim 23, wherein at least one of the stop and the carrier has at least one elastic shock absorber.

25. The device of claim 23, wherein the at least one stop has at least three circumferentially limited individual stops.

26. The device of claim 25, wherein the individual stops are uniformly distributed circumferentially around the carrier.

27. The device of claim 23, wherein the at least one stop is configured as a housing-side sleeve which encloses the carrier.

28. The device of claim 27, wherein the sleeve has an internal contour tapering in steps or continuously in the longitudinal dimension of the carrier.

29. The device of claim 27, wherein the sleeve has an external contour tapering in steps or continuously.

30. The device claim 27, wherein the sleeve is position-adjustable in a longitudinal dimension of the housing.

31. The device of claim 23, wherein the at least one stop has at least one carrier-side projection, which extends away from the carrier transversely to the longitudinal dimension, and at least one jaw arranged on the housing side and extending transversely to the longitudinal dimension, the jaw being spaced apart in the longitudinal dimension from the carrier-side projection.

32. The device of claim 31, wherein a distance between the projection and the jaws is settable.

33. The device of claim 31, wherein two housing-side jaws are arranged on both sides of the carrier-side projection.
